(19) United States
(12) Patent Application Publication
(10) Pub. No.: US 2008/0109858 A1
(43) Pub. Date: May 8, 2008

(54) Method and system for movie distribution

(76) Inventor: Francesco Maria Dominedo, Roma (IT)

Correspondence Address: Leffert Jay & Polglaze, P.A., P.O. Box 581009, Minneapolis, MN, 55458-1009, US

(21) Appl. No.: 11/593,242

(22) Filed: Nov. 6, 2006

(51) Int. Cl. H04N 7/173

(52) U.S. Cl. 725/87

(57) ABSTRACT

A method and an associated system for distributing movie contents among the public, comprising the steps of: (a) freely distributing a plurality of first movie contents via a service provider connected to a distribution net; (b) distributing, upon payment of a fee, a plurality of second movie contents via said provider, which second movie contents sequentially follow said first movie contents according to a movie plot; and (c) distributing a third movie content via movie theatre(s), which third movie content corresponds to the end of the movie according to said movie plot, said steps (a), (b) and (c) not being necessarily performed sequentially (FIG. 1).

### FIELD OF THE INVENTION

The present invention relates to a method and to a system for movie distribution among the public.

### BACKGROUND OF THE INVENTION

Nowadays, the way in which the new movies are presented and shown to the public is substantially the same as ten years ago. In particular, the movie is promoted mainly through conventional channels, typically in the form of trailers diffused by television and radio and by playbills or posters attached at street walls, and then it is shown in the movie theaters.

In relatively recent years, trailers or short versions thereof are also played or downloadable from the Internet.

However, such advertisement modes are not completely successful in attracting the interest of the potential audience, which in any case remains “passive” upon being targeted by the advertisement. In fact, a potential viewer gets interested in the movie mainly thanks to the advertising trailers, but in any case his direct relation with the movie itself is bounded to the period that he spends in the cinema. As said above, as a matter of fact the viewer acts as a passive subject with respect to the “event” constituted by the movie.

Furthermore, the trailers and posters are produced in a single or in very few versions, and therefore after the first watching the potential spectator tends to loose interest or indeed not to notice any more the advertisement.

Finally, the producer's incomes from the movie start when the movie itself is shown in the cinemas and they are mainly due to the tickets sold in the cinemas and to the successive phase of distribution for home entertainment, for instance as DVD.

### OBJECTS AND SUMMARY OF THE INVENTION

The technical problem underlying the present invention is that of overcoming the inconveniences mentioned in the previous section in conjunction with the prior art.

In particular, the object of the invention is to provide a new and advantageous method for the commercial distribution of movies and to provide the public with a new, interactive, amusing and very involving way to enjoy a movie.

Such objects are achieved by a method for distributing movie contents among the public, comprising the steps of:
(a) freely distributing one or more first movie contents via a service provider connected to a distribution net;
(b) distributing, upon payment of a fee, one or more second movie contents via said provider, which one or more second movie contents sequentially follow said one or more first movie contents according to a movie plot; and
(c) distributing a third movie content via movie theatre(s), which third movie content corresponds to the end of the movie according to said movie plot,
   said steps (a), (b) and (c) not being necessarily performed sequentially. According to the same inventive concept, the invention also provides a system for distributing movie contents, comprising:
service provider means for freely distributing one or more first movie contents, said provider means being connected to a distribution net; and
fee-payment means, associated with said provider means for distributing one or more second movie contents, sequentially following said one or more first movie contents according to a movie plot.

The main advantage of the method and system according to the invention is that of providing an effective distribution of a movie which involves the potential audience in an “active” way and which is capable of capturing and maintaining a continuous interest for the movie, from the initial distribution of its first contents up to the final vision at the movie theatre.

According to the present invention, the movie to be shown is split into several small episodes or presentations, which are distributed to the public through different means.

The first part of the movie, i.e., the prologue, is for instance made downloadable from the World Wide Web or is made viewable on suitable mobile phones.

The core of the movie is split into a number of episodes or presentations that are sequentially presented to the public. For instance, also in this case part of such episodes is downloadable from the World Wide Web and from mobile telephony servers, while the remaining part of such episodes is shown only at the movie theatres.

The final part of the movie, i.e., the epilogue, is shown at the cinema only. According to the present invention, the relation between the movie and the public starts through the World Wide Web and/or mobile phones and it is concluded in the movie theatres.

A subsequent distribution as DVD or similar means for home entertainment is also possible.

Advantageously, according to the present invention the movie is an amusing and involving experience for the viewer, since he is not a simply passive spectator, but on the contrary he is directly involved in the downloading of parts of the movie itself and he can choose when and how to watch them.

A further advantage of the present invention is that the movie spectator gets a wider enjoyment, since the subdivision of the movie in several episodes that are successively shown at different times creates expectation and interest for the following episodes.

A still further advantage of the present invention is that it is stimulating and challenging for the viewer, since it involves also modem technologies, as for instance the World Wide Web, mobile phone technology, portable multimedia devices (e.g. ipod) and so on.

An additional advantage is that the commercial exploitation of a movie according to the present invention can be got for a longer period of time, since it starts before the movie is shown in the cinemas. Moreover, the commercial exploitation of the movie directly involves several subjects as for instance movie distributors, mobile telephony operators, web sites and so on.

### BRIEF DESCRIPTION OF THE DRAWINGS

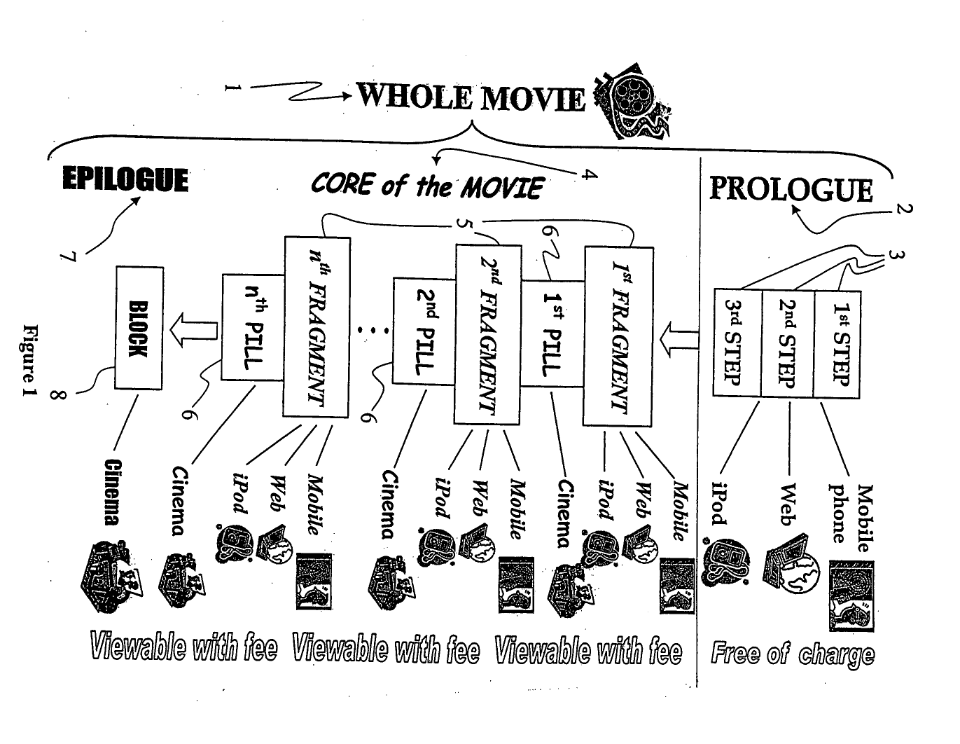

Other advantages, features and steps of the present invention will be made apparent in the detailed description of some embodiments thereof, given by way of example and not for limitative purposes, with reference to the drawing of the enclosed FIG. 1, which shows a schematic and exemplary representation of the distribution method and system according to the invention.

### DETAILED DESCRIPTION

With reference to FIG. 1, hereinafter it will be described a distribution and viewing method of a movie 1 according to one embodiment of the present invention.

As an example, the movie 1 may be a thriller movie with some elements typical of a horror story and it may have a dramatic structure with a mysterious and/or esoteric background. For instance, the movie 1 could have a length of 135 minutes.

The initial part of movie 1, which can be regarded as a prologue 2, is split into one or more sequential episodes 3, hereinafter called “steps”. Steps 3 are freely downloadable and/or viewable and/or audible through World Wide Web, mobile videophones, iPod, playstation ps2, iTV and similar means with an included video and/or audio player.

The steps aim at promoting the movie and intriguing the public and the potential audience. As an example, the prologue 2 has a length of fifteen minutes and it is divided into three steps 3 each one of five minutes length.

The central part of the movie 1, which can be regarded as a movie “core” 4, is split into a number of episodes belonging to two or more typologies of episodes. In the preferred embodiment of the invention there are two typologies of episodes and they are respectively called “fragments” 5 and “pills” 6. These fragments 5 and pills 6 are arranged in an alternate sequence according to a movie plot, i.e. each pill 6 is located between two fragments 5 (apart possibly from a last pill, which might have no following fragment).

In the preferred embodiment of the invention, each fragment 5 is downloadable and viewable through the same means of the steps 3, but the payment of an appropriate fee is requested for the viewing of each fragment 5. In the preferred embodiment, the pills 6 are shown only in the cinemas.

The goal of fragments 5 can be to show the protagonists of the movie and the troubles they encounter along the movie story, and more generally to keep alive the interest and the curiosity of the public.

The pills 6 are links between two successive fragments 5 and their goal is to widen, to make more mysterious and/or to explain what was shown in the preceding fragment 5. Also for pills 6 the aim is at getting the public more and more involved in the movie story.

As an example, the overall length of the fragments 5 can be sixty minutes, divided into twenty fragments of three minutes each, or twelve fragments of five minutes each. The overall length of the pills 6 is thirty minutes, divided into ten pills of three minutes each.

For instance, the file format of the downloadable steps 3 and fragments 5 can be asf, avi, divx, ipod, mov, mpeg1, mpeg2, mpeg4, pda, psp, wmv, 3gp, 3g2, or further file formats.

The final part of the movie 1, i.e. a movie epilogue 7, is constituted by a single part called block 8. The block 8 shows the conclusion of the movie story and the solution of the mysterious elements of the plot. In the preferred embodiment of the invention, the block 8 is shown only in the movie theatres. In such an occasion of viewing the conclusion of the story, the whole movie 1 will be shown at once in the cinemas, then allowing the viewing of the whole story also to people that have not previously view the steps 3, the fragments 5, and the pills 6.

As an example, the block 8 is thirty minutes long.

For instance, digital technologies can be adopted for the shooting of the movie. A mobile phone with an included camera can be used for the shooting of part of the movie and/or it can appear in the movie itself as a tool used by the protagonists.

For instance, a web site dedicated to the movie can be developed in order to give details about the background, the story, and/or the protagonists of the movie and to act as interface and interaction channel between the public and the event constituted by the movie.

Once the movie has been shown in the cinemas, it can be made further available to the public as home video, DVD, pay-tv and so on.

The present invention has been hereto described with reference to preferred embodiments thereof. It is understood that other embodiments might exist, all falling within the concept of the same invention, and all comprised within the protective scope of the claims hereinafter.

1. A method for distributing movie contents among the public, comprising the steps of:
(a) freely distributing one or more first movie contents via a service provider connected to a distribution net;
(b) distributing, upon payment of a fee, one or more second movie contents via said provider, which one or more second movie contents sequentially follow said one or more first movie contents according to a movie plot; and
(c) distributing a third movie content via movie theatre(s), which third movie content corresponds to the end of the movie according to said movie plot,
said steps (a), (b) and (c) not being necessarily performed sequentially.

2. The method according to claim 1, wherein said one or more first movie contents are a plurality of movie contents one following sequentially the other according to said movie plot.

3. The method according to claim 1, wherein said one or more second movie contents are a plurality of movie contents one following sequentially the other according to said movie plot.

4. The method according to claim 3, which provides for the distribution of fourth movie contents via movie theatre(s), each of said fourth movie contents being interposed between one second movie content and the subsequent one according to said movie plot.

5. The method according to claim 1, wherein said provider is selected in a group comprising an Internet provider and a mobile phone provider.

6. A system for distributing movie contents, comprising:
service provider means for freely distributing one or more first movie contents, said provider means being connected to a distribution net; and
fee-payment means, associated with said provider means for distributing one or more second movie contents, sequentially following said one or more first movie contents according to a movie plot.

7. The system of claim 6, wherein said provider means is selected in a group comprising an Internet provider and a mobile phone provider.
